(19) United States
(12) Patent Application Publication
(10) Pub. No.: US 2005/0078425 A1
(43) Pub. Date: Apr. 14, 2005

(54) Use of a thermal limit curve with a time overcurrent curve to provide thermal protection in a protective relay

(76) Inventors: Robert E. Morris, Viola, ID (US); Jacob J. Reidt, Spokane, WA (US); Brian S. Zabriskie, Moscow, ID (US); Carl V. Mattoon, Pullman, WA (US)

Correspondence Address: Cook ALex McFarron Manzo Cummings & Mehler, LTD.;Attn: David M. Mundt, Esq., 200 West Adams Street, Suite 2850, Chicago, IL, 60606, US

(21) Appl. No.: 10/684,046

(22) Filed: Oct. 10, 2003

(51) Int. Cl. H02H 3/08

(52) U.S. Cl. 361/93.1

(57) ABSTRACT

An overcurrent protective relay includes means for obtaining current values from a power line which are adjusted for application to and use by a processor portion of the relay. The processor evaluates the adjusted power line current values against an overcurrent curve by which, as the current increases from a continuous rating, the time to trip decreases. A thermal limit I²t curve is combined with the time overcurrent curve, the curves being arranged so that the thermal limit curve crosses over the time overcurrent curve at a selected current value. In such a case, the thermal limit curve controls the time to trip for current fault values above the selected current value and the inverse time overcurrent curve controls the time to trip for fault current values below the selected current value.

### TECHNICAL FIELD

This invention relates generally to protective relays, and more specifically concerns a protective relay which includes thermal protection.

### BACKGROUND OF THE INVENTION

In protective relays for power systems, a time overcurrent protection function is often used for power line protection. With time overcurrent protection, increases in power line current above a continuous current rating are recognized and a trip signal is provided to a circuit breaker to interrupt power to the line at a time “t”, with the value of time depending upon the amount of the fault current. Typically, the response will be on an inverse time basis, i.e. the larger the fault current the faster the time to trip, in accordance with a particular inverse time-current curve. Time overcurrent protection functions can be implemented with time overcurrent elements or electronically in a microprocessor (digital) relay.

Typically, inverse time/overcurrent curves for relay operation are set so that the relay will trip the circuit breaker before any damage is done to the relay by the fault current. In some cases, however, a high fault current may produce damage to the relay if the relay does not trip the circuit breaker soon enough. Changing a particular overcurrent curve to protect against high fault currents by fast tripping action may, however, not always be appropriate or desired. Hence, it would be desirable to have a simple, effective way to provide a fast tripping action at high fault current levels while using a delayed tripping inverse time curve for most fault current levels.

### SUMMARY OF THE INVENTION

Accordingly, the present invention is an overcurrent relay for use in a power system, comprising: means for obtaining current values from a power line, wherein the current values obtained from the line are decreased, i.e. adjusted, by current transformers for application to a processor; and a processor which in operation evaluates the adjusted current values with a preestablished response curve, wherein the preestablished response curve includes a combination of (a) an inverse time overcurrent curve portion in which, as fault current increases from a normal current value, the time to trip a circuit breaker for the power line decreases and (b) a thermal limit curve, wherein the thermal limit curve crosses the time overcurrent curve at a selected current value, such that the thermal limit curve controls the time to trip for fault current values greater than the preselected current value and the overcurrent curve controls the time to trip for fault current values less than the preselected current value.

### BRIEF DESCRIPTION OF THE DRAWINGS

FIG. 1 is a log-log drawing of a typical inverse-time overcurrent curve used in a protective relay.

FIG. 2 is a log-log drawing showing a typical thermal limit curve for a protective relay.

FIG. 3 is the combination of the present invention, a thermal limit curve with an inverse time overcurrent curve.

### BEST MODE FOR CARRYING OUT THE INVENTION

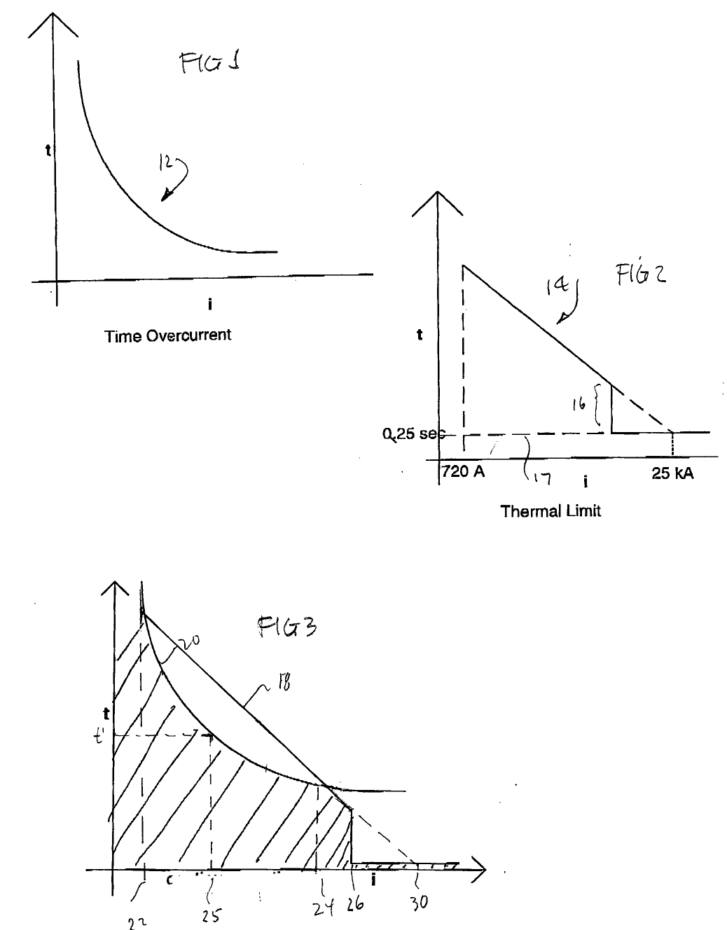

Inverse time overcurrent curves, implemented in a microprocessor (digital) relay, are well known. Previously, such inverse time overcurrent curves were typically implemented by overcurrent elements in electromechanical relays. With a time overcurrent curve, when fault current on the line rises above a continuous current rating value (the normal power line current value), a trip signal is generated by the relay and applied to the circuit breaker for the line, with the time to trip depending upon the size of the fault current. With an inverse time overcurrent curve, the higher the fault current, the faster the time to trip. The inverse time overcurrent curve shown at 12 in FIG. 1, which is a conventional time overcurrent curve, is plotted, with current along the horizontal axis and time along the vertical axis.

The location of curve 12 in the current/time plot will vary depending upon the particular application for the relay and the needs of the customer. In some applications, for instance, it is desirable to have a time delay, sometimes relatively large, before a trip signal is generated. Moving the curve upwardly, for instance, will increase the time for a trip signal to be produced for a given fault current. The curve may also be moved to the right, for larger fault currents, which will also delay the trip signal.

In some cases, however, the delay will be long enough that the fault current will actually do damage to the relay prior to the line being opened by the action of the circuit breaker. One such example is a relay which is self-powered, i.e. the relay has a power supply which operates from input power from the system current transformers, i.e. the current on the line is used to supply the power for the relay. High currents can damage the power supply if the delay in tripping is too long. In another example, the current transformers may burn out due to the high fault current flowing through the CTs for too long a time.

In most applications, with typical values of fault current, the relay will operate to produce a trip signal before any damage is done to the relay. However, as noted above, in some cases, a delay in the trip is desirable. The present invention protects the relay against damage when the relay is using inverse time overcurrent curves which have a significant delay. This is accomplished by overlaying a thermal limit curve, such as an I²t curve, over the time overcurrent curve. A representative I²t curve is shown at 14 in FIG. 2, in a log-log diagram of current (horizontal axis) verses time (vertical axis). The I²t curve in FIG. 2 is a straight line, due to the log-log plot. The thermal limit curve indicates the thermal capability of the relay, i.e. what it can withstand before failing. In the thermal limit curve of FIG. 2, the continuous current rating (normal current) is shown at 720 amps, with a maximum current of 25 k amps, and a time response of 0.25 seconds, as one example, for a particular relay. These numbers can of course be varied, depending upon the particular relay design.

FIG. 2 also illustrates a typical, but not necessary, aspect of a thermal limit curve, involving an instantaneous current value which is close to, but less than, the maximum fault current value for the relay. This part of the curve is shown at 16. This value of current, which will vary depending upon the design of the relay, is the current value at which the particular A/D (analog-digital) converter used in the relay will go into saturation. The relay in effect will be unable to detect any higher currents than this value. Accordingly, the thermal limit curve is adjusted to provide a response at this fault current value, as if the fault current had actually reached the maximum value for the relay, i.e. 25 kA in FIG. 2. The curve 14 in essence “cuts off” at a specific fault current prior to the maximum fault current.

However, it is certainly possible that a relay may have an A/D converter which does not saturate prior to the fault current reaching the relay's maximum current. In such a case, the thermal limit curve will continue on a straight line path to the maximum (fastest) time response line 17 of the relay, instead of dropping immediately to the maximum response line 17.

In the present invention, referring now to FIG. 3, a thermal limit curve 18, such as the curve in FIG. 2, is overlaid or superimposed, operationally, on a time overcurrent curve 20, such as shown in FIG. 1. The relay in such a case will respond with a trip signal based on whichever curve provides the fastest response for a particular value of fault current. For instance, in FIG. 3, from the point of normal values of current 22, until the point of current value 24, the inverse time overcurrent curve will produce a faster trip response and will in fact control the response of the relay. Between line current value 22 and line current value 24, the time overcurrent curve 20 response is fastest and will produce a trip signal at a time “t” associated with the particular fault current. At current point 25, for example, the relay will respond with a trip signal at time “t′”. At line current value 24, however, the thermal limit curve 18 crosses the time overcurrent curve 20 and will provide a faster response to that current and currents greater in magnitude, thus protecting the relay against damage for those high values of current, while allowing a slower trip response for lower values of fault current. The I²t curve in FIG. 3 also includes an immediate decline in response time at an A/D saturation point. However, I²t curve 18 (a straight line in the log-log plot of FIG. 3) could continue on a straight line all the way to the maximum current point 30, which has the minimum time response of the relay.

Hence, any fault current value above point 26 will result in a time to trip response “t” in accordance with the thermal limit line, i.e. the I²t line, as opposed to the time overcurrent curve, which remains above the I²t line, when the current is above current value 24. In one example, the I²t line=156×10⁶ amp²-seconds. However, this is for illustration only and will vary depending upon the particular relay design.

Accordingly, the combination of a thermal limit curve (I²t in the preferred embodiment) curve with an inverse time overcurrent curve allows the use of inverse time overcurrent curves with delays in typical tripping time, which may be advantageous in particular applications, without risking damage to the relay for high current faults.

Although a preferred embodiment of the invention has been disclosed for purposes of illustration, should be understood the various change, substitutions and modifications may be incorporated in the invention without departing from the spirit of the invention, which is defined by the claims which follow:

1. An overcurrent protective relay for use in a power system, comprising:
means for obtaining current values from a power line, which values are adjusted for application to a processor; and
a processor for evaluating the adjusted current values with a preestablished response curve, wherein the preestablished response curve includes a combination of (a) an inverse time overcurrent curve portion in which, as fault current increases from a normal current value, the time to trip a circuit breaker for the power line decreases, and (b) a thermal limit curve, wherein the thermal limit curve crosses the time overcurrent curve at a selected current value, such that the thermal limit curve controls the time to trip the circuit breaker for fault current values greater than the preselected current value and the overcurrent curve controls the time to trip for fault current values less than the preselected current value.

2. The relay of claim 1, wherein the selected thermal limit curve is an I²t curve.

3. The relay of claim 1, wherein the time overcurrent curve is characterized such that without the thermal limit curve, high fault currents will cause damage to the relay.

4. The relay of claim 1, wherein the thermal limit curve includes a feature of producing a trip signal at a selected speed when the current reaches a value which saturates an A/D converter portion of the relay.

5. The relay of claim 1, wherein the time overcurrent curve can be adjusted to change the response of the relay.
